(19) United States
(12) Patent Application Publication
(10) Pub. No.: US 2019/0047841 A1
(43) Pub. Date: Feb. 14, 2019

(54) DATA EXCHANGE AND RE-SUPPLY INFRASTRUCTURE FOR VEHICLES

(71) Applicant: Intel Corporation, Santa Clara, CA (US)

(72) Inventors: SHERRY CHANG, El Dorado Hills, CA (US); LINDA HURD, Cool, CA (US); CHAITANYA SREERAMA, Hillsboro, OR (US); XUE YANG, San Jose, CA (US); DENICA LARSEN, Portland, OR (US)

(21) Appl. No.: 16/146,573

(22) Filed: Sep. 28, 2018

(51) Int. Cl. B67D 7/04; G05D 1/00; G05D 1/02; G07C 5/00

(52) U.S. Cl. CPC B67D 7/0401; G05D 1/0088; G05D 2201/0213; G07C 5/008; G05D 1/0225

(57) ABSTRACT

Apparatuses, systems, and methods associated with an infrastructure for re-charging/refueling and exchanging data with vehicles are disclosed herein. In embodiments, an apparatus for servicing a computer-assisted or autonomous driving (CA/AD) vehicle may include an energy re-supply unit to re-charge or re-fuel the vehicle, a communication unit to exchange data with in-vehicle electronics of the vehicle, a memory device coupled to the communication unit to store data received from the in-vehicle electronics, a networking unit to couple the memory device to a network, the networking unit to provide for exchange of data between the memory device and another device coupled to the network, and a control unit coupled to the energy re-supply unit, the communication unit, the memory device and the networking unit to control operations of the energy re-supply unit, the communication unit, the memory device and the networking unit. Other embodiments may be described and/or claimed.

### TECHNICAL FIELD

The present disclosure relates to the field of computer-assisted vehicles and/or autonomous driving vehicles. More particularly, the present disclosure relates to an infrastructure for re-charging/refueling, calibrating, and exchanging/transferring data with computer-assisted vehicles and/or autonomous driving vehicles via a secured connection.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

The development of computer-assisted vehicles and autonomous driving vehicles has led to large amounts of data being captured by the vehicles. It is often desirable to transfer the captured data from the vehicles, such as for analysis of the data and/or to free up space in memory devices of the vehicles to allow for capture of further data. Legacy approaches have utilized mobile systems (such as global systems for mobile communication (GSM) and/or universal mobile telecommunications system (UMTS)) to transfer the captured data from the vehicles.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example infrastructure, according to various embodiments.

FIG. 2 illustrates an example system, according to various embodiments.

FIG. 3 illustrates an example infrastructure arrangement, according to various embodiments.

FIG. 4 illustrates a bottom view of an example infrastructure, according to various embodiments.

FIG. 5 illustrates a bottom view of another example infrastructure, according to various embodiments.

FIG. 6 illustrates an example procedure for an infrastructure, according to various embodiments.

FIG. 7 illustrates further operations of the example procedure of FIG. 6 for an infrastructure, according to various embodiments.

FIG. 8 illustrates another operation of the example procedure of FIG. 6 for an infrastructure, according to various embodiments.

FIG. 9 illustrates an example computer-readable non-transitory storage medium that may be suitable for use to store instructions that cause an apparatus, in response to execution of the instructions by the apparatus, to practice selected aspects of the present disclosure.

### DETAILED DESCRIPTION

Apparatuses, systems, and methods associated with an infrastructure for re-charging/refueling and exchanging data with vehicles are disclosed herein. In embodiments, an apparatus for servicing a computer-assisted or autonomous driving (CA/AD) vehicle may include an energy re-supply unit to re-charge or re-fuel the vehicle, a communication unit to exchange data with in-vehicle electronics of the vehicle, a memory device coupled to the communication unit to store data received from the in-vehicle electronics, a networking unit to couple the memory device to a network, the networking unit to provide for exchange of data between the memory device and another device coupled to the network, and a control unit coupled to the energy re-supply unit, the communication unit, the memory device and the networking unit to control operations of the energy re-supply unit, the communication unit, the memory device and the networking unit.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” refers to, is a part of, or includes an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

As used herein, the term “unit” refers to application specific circuitry that is to perform the corresponding operations described throughout this disclosure. The term “unit” further refers to physical elements coupled to the application specific circuitry, such as connectors, and/or fuel hoses and nozzles with operation controlled by the circuitry.

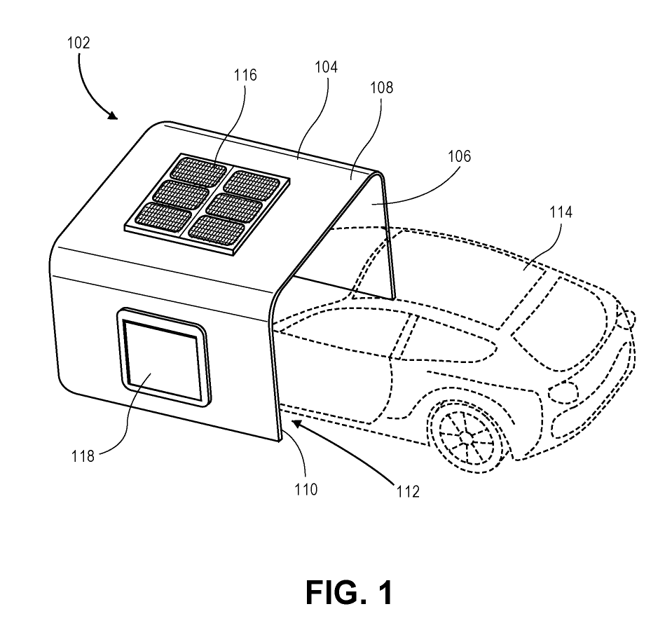

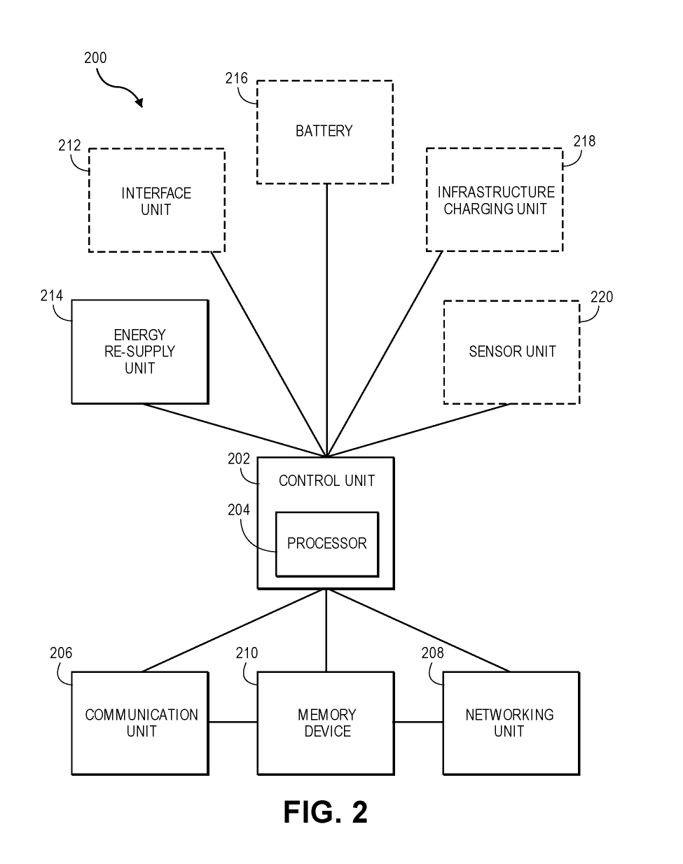

FIG. 1 illustrates an example infrastructure 102, according to various embodiments. The infrastructure 102 comprises a physical structure that houses a system (see FIG. 2) to communicate with in-vehicle electronics of a vehicle 114, such as a computer-assisted and/or autonomous driving (CA/AD) vehicle, and re-charge or re-fuel the vehicle 114. The vehicle 114 has an engine, transmission, axles, wheels and so forth. Further, vehicle 114 includes an in-vehicle infotainment (IVI) system having a number of infotainment subsystems/applications, e.g., an instrument cluster subsystem/applications, a front-seat infotainment subsystem/application, such as a navigation subsystem/application, a media subsystem/application, a vehicle status subsystem/application and so forth, and a number of rear-seat entertainment subsystems/applications. The IVI system is coupled to and/or is operated by the in-vehicle electronics.

The infrastructure 102 provides for communicating with the in-vehicle electronics while re-charging/re-fueling the vehicle 114, communicating with the in-vehicle electronics at different times from when the vehicle 114 is being re-charged/re-fueled, or some combination thereof. For example, the infrastructure 102 can exchange data with the in-vehicle electronics while the vehicle is not re-charging/re-fueling the vehicle 114. Further, the infrastructure 102 may re-charge/re-fuel the vehicle 114 while data is not being exchanged with the in-vehicle electronics.

The infrastructure 102 comprises a body 104. The body 104 includes an inner wall 106 and an outer wall 108. The system, or some portion thereof, housed by the infrastructure 102 is located between the inner wall 106 and the outer wall 108, and is enclosed between the inner wall 106 and the outer wall 108. The infrastructure 102 includes one or more end walls 110 that connect the inner wall 106 and the outer wall 108, and enclose the area between the inner wall 106 and the outer wall 108. The inner wall 106, the outer wall 108, and the end walls 110 provide protection to the system, or portion thereof, enclosed within the infrastructure 102 from environmental conditions (such as water, rain, and/or particles) external to the infrastructure 102. Accordingly, the infrastructure 102 protects the system, or portion thereof, from damage that may occur due to external conditions. The protection from environmental conditions allows the infrastructure 102 to be located in multiple different locations that could be hazardous to the system if not protected by the infrastructure 102, such as residential garages, commercial parking garages (such as for hospitals and/or business parking), open parking lots (such as for grocery stores, business parks, and/or medical facilities), parking lots with solar farm car ports, car repair facilities, car dealerships, entrances to national/state/local parks, historical locations, and/or other local points of interest.

The body 104 of the infrastructure 102 is upside-down U-shaped. When placed on a surface, the body 104 forms a recess 112 in which a vehicle 114, or some portion thereof, can be located or positioned. In other embodiments, the body 104 may be arch-shaped. Further, it is to be understood that the infrastructure 102 may be any shape or size that can house the system, or portion thereof, in other embodiments.

The infrastructure 102 is a stand-alone infrastructure. In particular, the infrastructure 102 may be installed in a location without requiring a wired connection to any external systems. In other embodiments, the infrastructure 102 may be wiredly connected to other systems, such as a power grid that can provide power to the infrastructure 102 and/or for re-charging the vehicle 114, a network entity (such as a node of a network), or some combination thereof.

The infrastructure 102, in some embodiments, includes one or more solar panels 116 located at, or coupled to, the outer wall 108. In particular, the infrastructure 102 may include the solar panels 116 in embodiments where a system located within the infrastructure 102 includes a battery. The solar panels 116 may be coupled to the battery of the system and may charge the battery. In other embodiments, the solar panels 116 may be omitted.

The infrastructure 102 further includes one or more user interfaces 118. The user interfaces 118 may be located at, or coupled to, the outer wall 108. In other embodiments, the user interfaces 118 may be located at, or coupled, to the inner wall 106. The user interfaces 118 comprise a display, a keyboard, a touch screen, a touch pad, a mouse, or some combination thereof. The user interfaces 118 are coupled to an interface unit of the infrastructure 102 and allow a user to interact with a system of the infrastructure 102. In other embodiments, the user interfaces 118 may be omitted.

In some embodiments, the outer wall 108 may be formed of a material that absorbs radio waves (such as conductive metals), may be coupled to ground of either the system or earth ground, or some combination thereof. The outer wall 108 being formed of the material and/or coupled to ground or earth ground may reduce electromagnetic interference that may affect wireless signals transmitted between the vehicle 114 and the system housed by the infrastructure 102. Further, the outer wall 108 being formed of the material and/or coupled to ground or earth ground may limit propagation of wireless signals transmitted between the vehicle 114 and the system to within the recess 112, or reduce an amount of propagation of the wireless signals outside of the recess 112.

FIG. 2 illustrates an example system 200, according to various embodiments. In particular, the system 200, or some portion thereof, is housed within an infrastructure (such as the infrastructure 102 (FIG. 1)).

The system 200 includes a control unit 202. The control unit 202 is coupled to one or more of the elements of the system 200 and controls operation of the elements. The control unit 202 comprises circuitry coupled to the elements of the system 200. The control unit 202 may further include one or more processors 204. For example, the control unit 202 may include one or more processor cores (CPUs), one or more graphics processor units (GPU), one or more accelerators, such as computer vision (CV) and/or deep learning (DL) accelerators.

The system 200 further includes a communication unit 206. The communication unit 206 is coupled to the control unit 202. The control unit 202 can control operation of the communication unit 206. The communication unit 206 can establish a connection with in-vehicle electronics of a vehicle (such as the vehicle 114 (FIG. 1)) and can exchange data with the in-vehicle electronics when the communication unit 206 is communicatively coupled with the in-vehicle electronics. The communication unit 206 can be communicatively coupled with the in-vehicle electronics when the vehicle is located within a proximity of the infrastructure. The communication unit 206 includes circuitry for establishing the connection with the in-vehicle electronics and exchanging data with the in-vehicle electronics. The communication unit 206 may include wireless circuitry for establishing a wireless connection with the in-vehicle electronics (such as one or more antennas) in some embodiments. For example, the communication unit 206 may include circuitry that implements Bluetooth®, Near Field Communication (NFC), WiFi, and so forth. In some embodiments, the wireless connection may be established by a contact component of the communication unit 206, where the communication unit 206 establishes the wireless connection when the contact component is in contact with the vehicle. In other embodiments, the communication unit 206 may include one or more wires for establishing a wired connection with the in-vehicle electronics. The communication unit 206 may provide a private, encrypted connection with the in-vehicle electronics. The private, encrypted connection is not limited to tethered electrics and can include additional approved devices.

The system 200 further includes a networking unit 208. The networking unit 208 is coupled to the control unit 202. The control unit 202 can control operation of the networking unit 208. The networking unit 208 provides for exchange of data with a network external to the infrastructure, such as exchanging data via another device coupled to the network. The networking unit 208 may be wiredly connected to the device in some embodiments. In other embodiments, the networking unit 208 may be wirelessly connected to the device. The networking unit 208 provides a private, encrypted connection with the network.

The system 200 further includes a memory device 210. The memory device 210 is coupled to the control unit 202, the communication unit 206, and the networking unit 208. The memory device 210 may include flash drives, hard drives, compact disc read-only memory (CD-ROM) and so forth. The control unit 202 can control operation of the memory device 210. The memory device 210 can receive and store data received by the control unit 202, the communication unit 206, and/or the networking unit 208. Further, data may be retrieved from the memory device 210.

The communication unit 206 can store data received from the in-vehicle electronics to the memory device 210. For example, the communication unit 206 can retrieve data from the in-vehicle electronics and transmit the data to the memory device 210 for storage. The data retrieved from the in-vehicle electronics can include route information, vehicle operation information, vehicle system operation information, data captured by sensors of the vehicle, or some combination thereof. Further, the communication unit 206 can retrieve data from the memory device 210 and transmit the data to the in-vehicle electronics. The data transmitted to the in-vehicle electronics may include software updates, diagnostic information, calibration information, tour guide information, or some combination thereof.

The control unit 202 can perform analysis of data retrieved from the in-vehicle electronics by the communication unit 206 to determine whether any action should be taken based on the data. For example, the control unit 202 can analyze the data to identify operation characteristics of one or more vehicle systems of the vehicle and determine whether the vehicle systems are operating properly. If the control unit 202 determines that a vehicle system is not operating properly, the control unit 202 can cause the user to be informed of the improper operation, can cause the in-vehicle electronics associated with the vehicle system to be reconfigured (such as via the communication unit 206) to correct the operation, can cause in-vehicle electronics to be updated (such as via the communication unit 206) to correct the operation, or some combination thereof. Further, the control unit 202 can analyze the software (including firmware) of the in-vehicle electronics and determine whether the software should be updated or should be reverted to an earlier version of the software. If the control unit 202 determines that the software should be updated or reverted, the control unit 202 can cause the software to be updated or reverted (such as via the communication unit 206). The control unit 202 can further cause the previous version of the software to be stored in the memory device 210 and/or transmitted to the network via the networking unit 208 such that software can be reverted to the previous version of the software.

The networking unit 208 can store data received from the network to the memory device 210. For example, the networking unit 208 can retrieve data from the network and transmit the data to the memory device 210 for storage. The data retrieved from the network can include software updates, diagnostic information, calibration information, tour guide information, or some combination thereof. Further, the networking unit 208 can retrieve data from the memory device 210 and transmit the data to the network. The data transmitted to the network may include route information, vehicle operation information, vehicle system operation information, data captured by sensors of the vehicle, or some combination thereof.

The system 200 further includes an interface unit 212. The interface unit 212 is coupled to the control unit 202. The interface unit 212 provides for interaction between a user of the infrastructure and the system 200. The interface unit 212 includes wireless circuitry and can establish a wireless connection with a device of the user or the vehicle, such as a smart-phone, a tablet, a computer, and/or a user interface of the vehicle. In other embodiments, the interface unit 212 may include and/or be coupled to a user interface (such as the user interfaces 118 (FIG. 1)) located on the infrastructure.

The interface unit 212 allows the user to interact with the system 200 and define or alter one or more operations of the system. For example, the interface unit 212 can allow the user to determine what data is retrieved by the communication unit 206 from the in-vehicle electronics and/or what data is to be transmitted by the networking unit 208 to the network. Further, the interface unit 212 can allow the user to define an update policy for updating software of the in-vehicle electronics and/or define configuration of one or more elements of the vehicle controlled by the in-vehicle electronics.

The interface unit 212 further allows the system 200 to communicate with the user. For example, the interface unit 212 can display (via the device of the user and/or the user interface located on the infrastructure) information to the user. In particular, the control unit 202 can cause the interface unit 212 to display information to the user, such as predicted charge time, diagnostic results, information regarding software updates, and/or information regarding the transfer of data via the system 200.

In some embodiments, the interface unit 212 may further facilitate user authentication. In particular, the system 200 may authenticate the user as an owner of the vehicle and/or an authorized user of the vehicle. For example, the system 200 may authenticate a user as an owner or authorized user of a privately owned or leased vehicle, or may authenticate the user as an authorized user of a company-owned vehicle or a rental car. The interface unit 212 detects or receives information utilized for authentication of the user, such as input of a passcode, identification of other devices registered to the user being within a proximity of the infrastructure, biometric information, voice recordings, or some combination thereof. The interface unit 212 or the control unit 202 compares the information with information associated with authorized users and determines whether the user is authorized. The information associated with the authorized users may be received from the in-vehicle electronics via the communication unit 206, may be retrieved from the network via the networking unit 208, or may be retrieved from the memory device 210.

In response to the interface unit 212 or the control unit 202 determining that the user is authorized, the system 200 may provide full functionality to the user, including allowing the user to define which data is transferred from the vehicle, the update policy, and/or the configuration of one or more elements of the vehicle. Further, the control unit 202 may identify storage locations within the memory device 210 and/or on the network associated with the authorized user and direct data retrieved from the vehicle to the identified storage locations.

In response to the interface unit 212 or the control unit 202 determining that the user is not authorized, the system 200 may provide reduced or limited functionality to the user, such as preventing retrieval of the data from the vehicle, preventing definition of the data to be retrieved from the vehicle, preventing the user from changing the update policy and/or the configuration of one or more elements of the vehicle, or some combination thereof. In other embodiments, the system 200 may not provide any functionality to the user (i.e., prevents charging of the vehicle and establishment of a connection with the in-vehicle electronics) when it is determined that the user is not authorized. Further in embodiments where it is determined that the user is not authorized, the control unit 202 may utilize the network (via the networking unit 208) to transmit a message to an authorized user or a defined user who can provide authorization seeking authorization for the user who has previously been determined to be not authorized. The message may include identification of the user for who authorization is being sought. In instances where the authorized user or defined user indicates that the user that has previously been determined to be not authorized should not be authorized, the control unit 202 may utilize the network (via the networking unit 208) to inform authorities of not authorized operation of the vehicle. In some embodiments, the interface unit 212 may be omitted.

The system 200 further includes an energy re-supply unit 214. The energy re-supply unit 214 is coupled to the control unit 202. The energy re-supply unit 214 can re-charge or re-fuel the vehicle. In particular, the energy re-supply unit 214 includes a connector to couple to the vehicle and re-charge or re-fuel the vehicle. The connector of the energy re-supply unit 214 can be coupled to a portion of the in-vehicle electronics (such as batteries and/or capacitors) of the vehicle via the connector and can re-charge the portion of the in-vehicle electronics. In other embodiments, the energy re-supply unit 214 can be coupled to a portion of a fuel system (such as a gas tank and/or a hydrogen tank) of the vehicle via the connector and can re-fuel the portion of the fuel system. The energy re-supply unit 214 can re-charge or re-fuel the vehicle while the communication unit 206 is exchanging data with in-vehicle electronics, can re-charge or re-fuel the vehicle without the communication unit 206 exchanging data with the in-vehicle electronics, or the communication unit 206 can exchange data with the in-vehicle electronics while the energy re-supply unit 214 does not re-charge or re-fuel the vehicle.

The system 200 further includes a battery 216. The battery 216 is coupled to the control unit 202. The battery 216 can provide power to the system 200 and/or be utilized for re-charging the vehicle. The battery 216 may be re-charged by a connection between the system and a power grid. In some embodiments, the system 200 may include an infrastructure charging unit 218. The infrastructure charging unit 218 is coupled to the control unit 202 and/or the battery 216. The infrastructure charging unit 218 can charge the battery 216. The infrastructure charging unit 218 may be coupled to the power grid, and/or may include or be coupled to alternative power sources (such as solar panels 116 (FIG. 1) and/or wind power generators), and may utilize the power grid and/or the alternative power sources to charge the battery 216. In other embodiments, the battery 216 and/or the infrastructure charging unit 218 may be omitted.

The system further includes a sensor unit 220. The sensor unit 220 can sense the presence of a vehicle within a proximity of the infrastructure. In embodiments where the infrastructure includes a recess (such as the recess 112 (FIG. 1)) to receive a vehicle, the sensor unit 220 may detect when a vehicle, or some portion thereof, is located within the recess. The sensor unit 220 may include, or may be coupled to, a sensor (such as a laser sensor, an optical sensor, an inductive sensor, and/or a contact sensor) that senses the presence of the vehicle. When the sensor unit 220 does not detect the presence of a vehicle, the control unit 202 may power down one or more elements of the system 200 (such as the communication unit 206, the networking unit 208, the energy re-supply unit 214, and/or the interface unit 212) to save power in some embodiments. When the sensor unit 220 detects the presence of a vehicle, the control unit 202 may power on and/or activate one or more elements of the system 200 (such as the communication unit 206, the networking unit 208, the energy re-supply unit 214, and/or the interface unit 212). In other embodiments, the sensor unit 220 may be omitted. In embodiments where the sensor unit 220 is omitted, the elements of the system 200 may remain active or a portion of the elements (such as the communication unit 206 and/or the networking unit 208) may be activated and/or power on upon the energy re-supply unit 214 re-charging or re-fueling the vehicle.

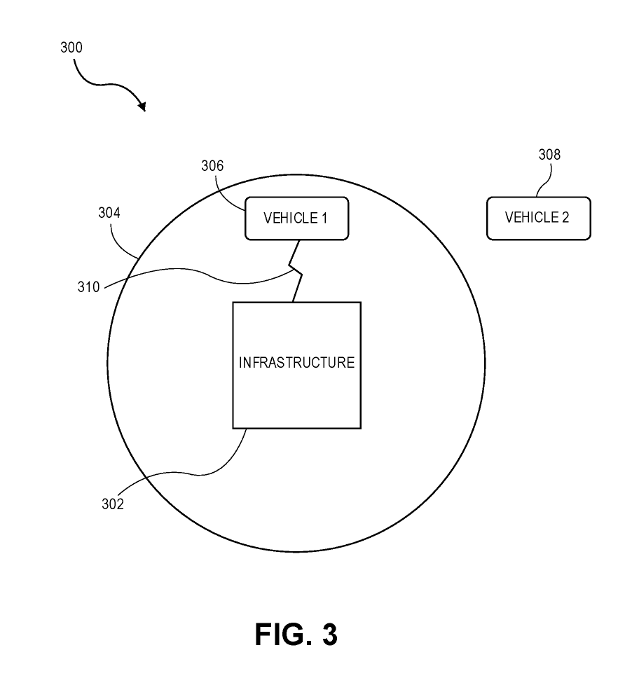

FIG. 3 illustrates an example infrastructure arrangement 300, according to various embodiments. The infrastructure arrangement 300 includes an infrastructure 302. The infrastructure 302 includes one or more of the features of the infrastructure 102 (FIG. 1). Further, the infrastructure 302 houses a system (such as the system 200 (FIG. 2)).

The infrastructure arrangement 300 has a communication range 304. The communication range 304 defines an area where a communication unit (such as the communication unit 206 (FIG. 2)) can establish a connection with the in-vehicle electronics of a vehicle and exchange data with the in-vehicle electronics. When a vehicle is proximally disposed within the communication range 304, the communication unit can establish a connection with the vehicle (in particular, the in-vehicle electronics of the vehicle) and be communicatively coupled with the vehicle. The communication range 304 may encompass an entire area where the communication unit is capable of establishing a connection, or may be configured to encompass a smaller area. For example, the communication range 304 may be configured to encompass the area within a recess of an infrastructure (such as the recess 112 (FIG. 1)) in some embodiments, where the communication unit is limited to establishing the connection with the vehicle when a portion of the vehicle is located within the recess.

The infrastructure arrangement 300 further includes a first vehicle 306 and a second vehicle 308. The first vehicle 306 is proximally disposed near the infrastructure 302, within the communication range 304. Based on the first vehicle 306 being within the communication range 304, the communication unit of the infrastructure has established a connection 310 with in-vehicle electronics of the vehicle, allowing the communication unit and the in-vehicle electronics to exchange data. The second vehicle 308 is disposed outside of the communication range 304. Based on the second vehicle 308 being disposed outside of the communication range 304, there is no connection established between the communication unit and the in-vehicle electronics of the second vehicle 308.

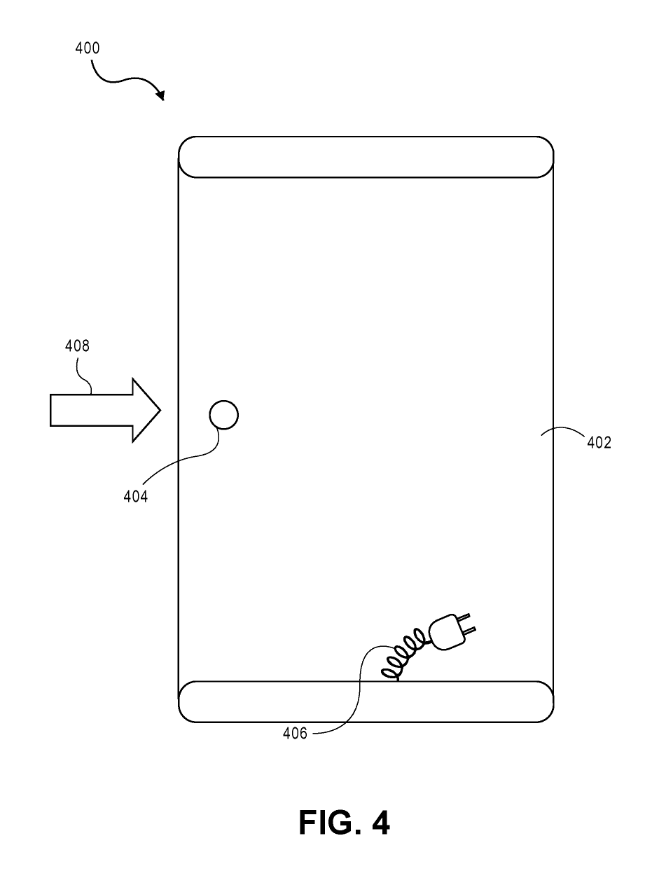

FIG. 4 illustrates a bottom view of an example infrastructure 400, according to various embodiments. The infrastructure 400 includes one or more of the features of the infrastructure 102 (FIG. 1). The view illustrates an inner wall 402 of the infrastructure 400 viewed from the bottom and looking up into a recess (such as the recess 112 (FIG. 1)).

The infrastructure 400 includes a sensor 404. The sensor 404 comprises a laser sensor, an optical sensor, or some combination thereof. The sensor 404 is located at, or coupled to, the inner wall 402 and directed into the recess. The sensor 404 is located toward a side of the infrastructure 400 where a vehicle is intended to enter, as illustrated by arrow 408. In other embodiments, the sensor 404 may be located toward a center of the infrastructure 400. A sensor unit (such as the sensor unit 220 (FIG. 2)) is coupled to the sensor 404 and may utilize the sensor 404 to detect when a vehicle, or some portion thereof, is located within the recess. In other embodiments, the sensor 404 may be omitted.

The infrastructure 400 further includes a connector 406. The connector 406 is coupled to an energy re-supply unit (such as the energy re-supply unit 214 (FIG. 2)) and can be utilized by the energy re-supply unit to re-charge or re-fuel the vehicle when the connector 406 is coupled to the vehicle. For example, the connector 406 comprises a wired connector in some embodiments, and can couple to a charging port of the vehicle to re-charge a portion of the in-vehicle electronics (such as a battery and/or a capacitor) of the vehicle. In other embodiments, the connector 406 comprises a fuel hose and nozzle, and can couple to a filler pipe of a fuel tank to re-fuel the fuel tank.

The connector 406 extends from the infrastructure 400 to couple with the vehicle. In particular, the connector 406 extends from the inner wall 402 into the recess in the illustrated embodiment. In other embodiments, the connector 406 may extend from an outer wall (such as the outer wall 108 (FIG. 1) of the infrastructure 400 and may extend outside of the recess.

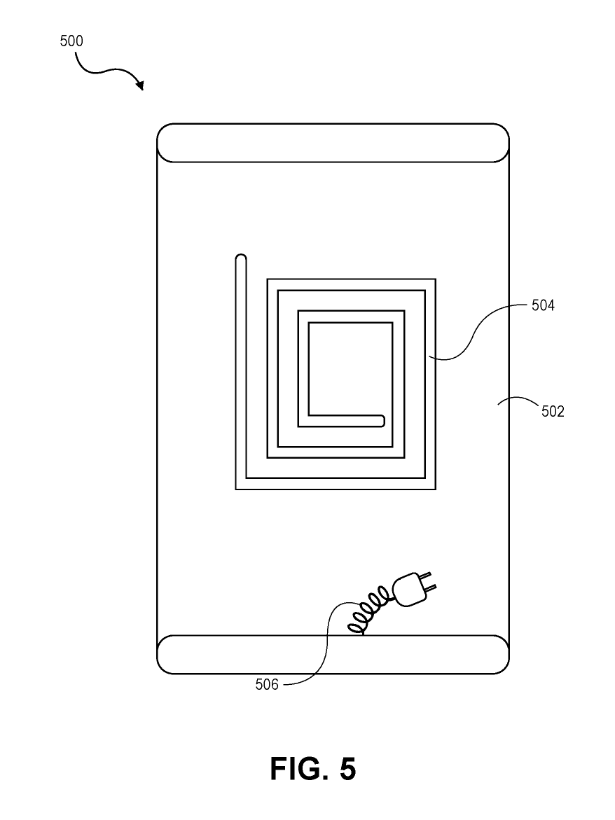

FIG. 5 illustrates a bottom view of another example infrastructure 500, according to various embodiments. The infrastructure 500 includes one or more of the features of the infrastructure 102 (FIG. 1) and/or the infrastructure 400 (FIG. 4). The view illustrates an inner wall 502 of the infrastructure 500 viewed from the bottom and looking up into a recess (such as the recess 112 (FIG. 1)).

The infrastructure 500 includes a sensor 504. The sensor 504 is housed within the infrastructure 500. The sensor 504 comprises an inductive sensor. In particular, the sensor 504 comprises an inductive coil in which current can be induced by moving metal near the inductive coil. A sensor unit (such as the sensor unit 220 (FIG. 2)) is coupled to the sensor 504 and may utilize the sensor 504 to detect when a vehicle, or some portion thereof, is located within the recess. In other embodiments, the sensor 504 may be omitted.

The infrastructure 500 further includes connector 506. The connector 506 includes one or more of the features of the connector 406 (FIG. 4).

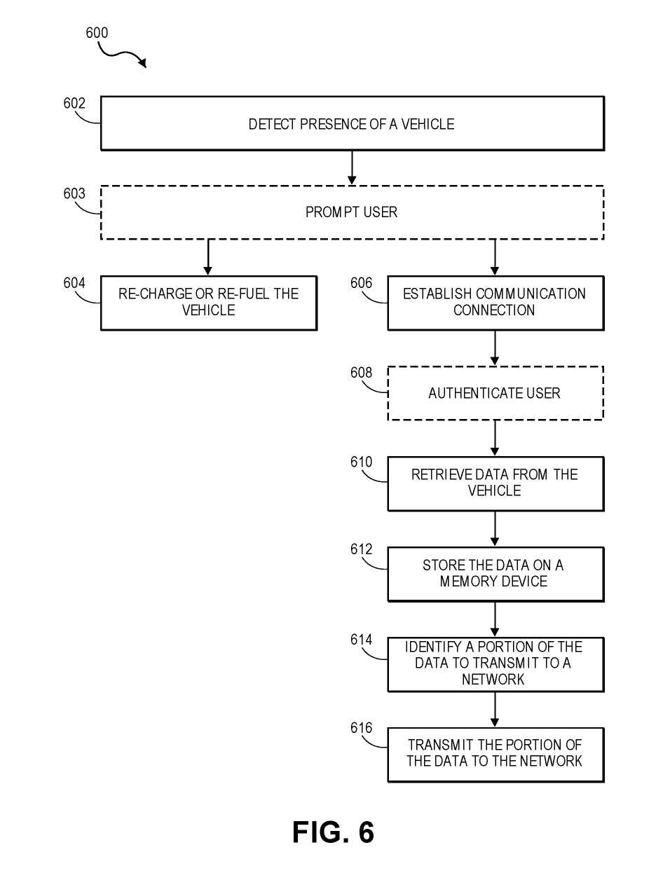

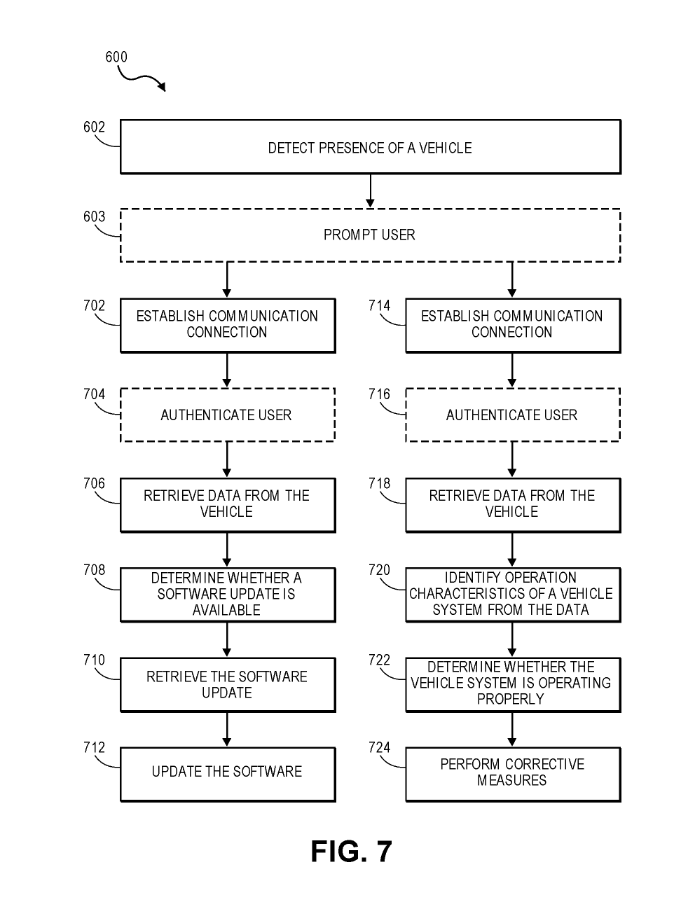

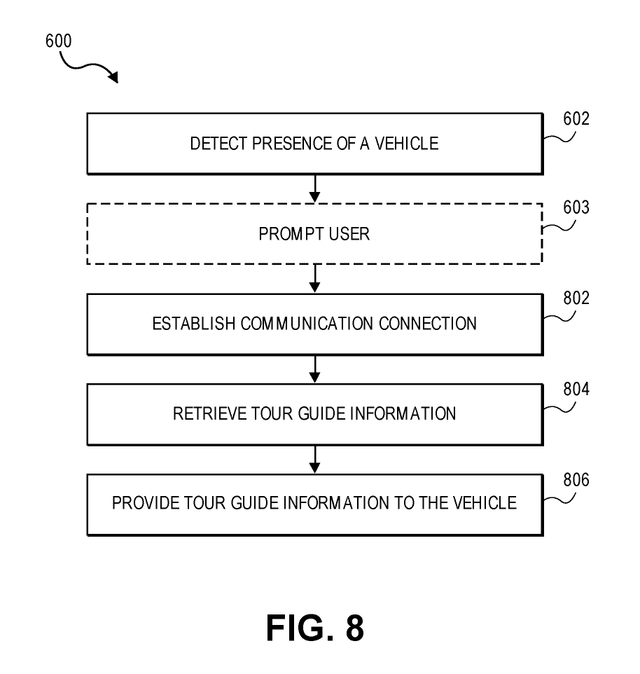

FIG. 6 illustrates an example procedure 600 for an infrastructure (such as the infrastructure 102 (FIG. 1), the infrastructure 400 (FIG. 4), and/or the infrastructure 500 (FIG. 5)), according to various embodiments. FIG. 6 illustrates two operations that can be performed by an infrastructure. The operations can be performed concurrently or separately. Further, the operations can be performed concurrently or separately from operations illustrated in FIG. 7 and FIG. 8.

In stage 602, the infrastructure detects the presence of a vehicle. For example, a sensor unit (such as the sensor unit 220 (FIG. 2)) of the infrastructure utilizes a sensor (such as the sensor 404 (FIG. 4), and/or the sensor 504 (FIG. 5)) to detect the presence of the vehicle. In other embodiments, a communication unit (such as the communication unit 206 (FIG. 2)) may receive a message from in-vehicle electronics of the vehicle that indicates the presence of the vehicle. Further, a control unit (such as the control unit 202 (FIG. 2)) may detect that a connector (such as the connector 406 (FIG. 4) and/or the connector 506 (FIG. 5)) of the infrastructure has been coupled to a vehicle to detect the presence of the vehicle.

From stage 602, the procedure 600 implements a user prompt operation in stage 603. In particular, the infrastructure prompts a user of the vehicle on which operations should be performed by the infrastructure. The operations may include any of the operations described in FIG. 6, FIG. 7, and/or FIG. 8, including a re-charge/re-fuel operation, a data download operation, a software update operation, a diagnostic operation, and a tour guide provision operation. Prompting the user includes displaying, via an interface unit (such as the interface unit 212 (FIG. 2)), a user prompt requesting indications of the operations to be performed by the infrastructure. The user prompt can be displayed on a display of the infrastructure, a touch screen of the infrastructure, a display of the vehicle, a device of a user of the vehicle, or some combination thereof. In response to receiving the indications of the operations to be performed by the infrastructure, the infrastructure may implement the indicated operations concurrently, at separate times, or some combination thereof. In other embodiments, stage 603 may be omitted and one or more operations may be initiated in response to the presence of the vehicle being detected.

In stage 604, the procedure 600 may implement a re-charge/re-fuel operation. The re-charge/re-fuel operation initiates at stage 604. In stage 604, the infrastructure re-charges or re-fuels the vehicle. Re-charging or re-fueling the vehicle may include detecting that the connector has been coupled to the vehicle. In other embodiments, re-charging or re-fueling may include detecting via an interface unit (such as the interface unit 212 (FIG. 2)) a user interaction with a user interface (such as the user interface 118 (FIG. 1)) that indicates that re-charging or re-fueling is to be initiated. In response to detecting the connector has been coupled to the vehicle or detecting the user interaction, an energy re-supply unit (such as the energy re-supply unit 214 (FIG. 2)) may determine whether the in-vehicle electronics of the vehicle are fully charged or whether a fuel tank of the vehicle is full. If the energy re-supply unit determines that the in-vehicle electronics are fully charged or the fuel tank is full, re-charge/re-fuel operation may be terminated. If the energy re-supply unit determines that the in-vehicle electronics are not fully charged or the fuel tank is not full, the energy re-supply unit may re-charge or re-fuel the vehicle via the connector.

The procedure 600 may implement a data download operation. The data download operation initiates at stage 606. In stage 606, the infrastructure may establish a communication connection with the vehicle. In particular, the communication unit of the infrastructure may establish a communication connection with the in-vehicle electronics of the vehicle. Establishing the communication connection may include a connection establishment procedure, where messages may be transmitted between the communication unit and the in-vehicle electronics. The communication unit transmits a connection request to the in-vehicle electronics in response to detecting the presence of the vehicle in some embodiments. In other embodiments, the in-vehicle electronics transmit a connection request to the communication unit. In response to receiving the connection request, the communication unit and the in-vehicle electronics may exchange messages to configure the communication unit and the in-vehicle electronics for exchange of data, such as setting a frequency of signals carrying the data, setting a timing for the transmissions, or some combination thereof. In some embodiments, establishing the communication connection can include identifying the vehicle.

In stage 608, the infrastructure authenticates a user. In particular, the interface unit or the control unit of the infrastructure authenticates a user. Authentication of the user includes retrieving information associated with the authorized users of the vehicle and comparing the information associated with the authorized user with information associated with the user being authenticated to determine if the user is authorized for the vehicle. If the interface unit or the control unit determines that the user is not authorized, the data download operation may be terminated, the data download operation may proceed with reduced functionality, the infrastructure may transmit a message to an authorized user or a defined user seeking authorization for the user, or some combination thereof. If the interface unit or the control unit determines that the user is authorized, the data download operation may proceed with full functionality. In some embodiments, stage 608 may be omitted.

In stage 610, the infrastructure retrieves data from the vehicle. In particular, the communication unit retrieves the data from the in-vehicle electronics of the vehicle. The data retrieved may be pre-defined, such as by configuration of the infrastructure, as defined by an authorized user, or some combination thereof. In other embodiments, the data retrieved may be defined by the user at the time of initiation of the data retrieval. In instances where the user is determined to be not authorized in stage 608, the amount of data retrieved from the in-vehicle electronics may be less than the data retrieved for an authorized user, the infrastructure may prevent the user from defining or redefining the data to be retrieved, or some combination thereof.

In stage 612, the infrastructure stores the data on a memory device (such as the memory device 210 (FIG. 2)) of the infrastructure. In particular, the communication unit transmits the data to the memory device for storage. The data is stored on the memory device 210 in a location associated with the user, associated with the vehicle, or some combination thereof.

In stage 614, the infrastructure identifies a portion of the data to be transmitted to a network. In particular, the control unit identifies a portion of the data retrieved from the in-vehicle electronics to be transmitted to the network. The portion of the data may be an entirety of the data retrieved from the in-vehicle electronics or less than all of the data retrieved from the in-vehicle electronics, or the control unit may determine that none of the data is to be transmitted to the network. The data to be transmitted may be pre-defined, such as by configuration of the infrastructure, as defined by an authorized user, or some combination thereof. In other embodiments, the data to be transmitted may be defined by the user at the time of initiation of the data transmission. In instances where the user is determined to be not authorized in stage 608, stage 614 may be omitted, the data to be transmitted may be less for the not authorized user than for an authorized user, the infrastructure may prevent the user from defining or redefining the data to be transmitted to the network, or some combination thereof.

In stage 616, the infrastructure transmits the portion of the data to the network. In particular, the networking unit may transmit the data to another device coupled to the network. In instances where the user is determined to be not authorized in stage 608 or the control unit determines that none of the data is to be transmitted to the network, stage 616 may be omitted.

FIG. 7 illustrates further operations of the example procedure 600 of FIG. 6 for an infrastructure, according to various embodiments. FIG. 7 illustrates two additional operations that can be performed by an infrastructure. The operations can be performed concurrently or separately. Further, the operations can be performed concurrently or separately from operations illustrated in FIG. 6 and FIG. 8.

The procedure 600 may initiate with stage 602, as described in relation to FIG. 6. The procedure 600 may implement one or more of the additional operations based on detecting the presence of the vehicle in stage 602. From stage 602, the procedure 600 may proceed to the user prompt operation in stage 603, as described in relation to FIG. 6.

In stage 702, the procedure 600 may implement a software update operation. The software update operation initiates at stage 702. In stage 702, the infrastructure establishes a communication connection with the vehicle. Establishing the communication connection in stage 702 includes the features of establishing the communication connection in stage 606 (FIG. 6).

In stage 704, the infrastructure authenticates a user. Authenticating the user in stage 704 includes the features of authenticating the user in stage 608 (FIG. 6). In instances where the user is determined to be not authorized, the software update operation may be terminated or may proceed with reduced functionality. In instances where the user is determined to be authorized, the software update operation proceeds with full functionality. In some embodiments, stage 704 may be omitted.

In stage 706, the infrastructure retrieves data from the vehicle. In particular, a communication unit (such as the communication unit 206 (FIG. 2)) may retrieve the data from the in-vehicle electronics of the vehicle. The data includes indications of the versions of software currently being operated by the in-vehicle electronics.

In stage 708, the infrastructure determines whether a software update is available. In particular, a control unit (such as the control unit 206 (FIG. 2)) compares the versions of the software currently being operated by the in-vehicle electronics with versions of the software stored on a memory device (such as the memory device 210 (FIG. 2)) of the infrastructure and/or the network coupled to the infrastructure. If the control unit determines that the versions of the software stored on the memory device or the network are newer versions than the software currently being operated by the in-vehicle electronics, the control unit determines that software updates are available.

Stage 708 may further include determining which software updates are to be implemented for the in-vehicle electronics. The control unit can determine that all available software updates should be implemented in some embodiments. In other embodiments, the control unit may determine that only a portion of the software updates should be implemented based on an update policy previously defined, based on user interactions from the user that define software updates to be implemented at the time of determining the available software updates, based on the authentication of the user, or some combination thereof. In instances where the user is determined to be not authorized in stage 704, the control unit may determine that software updates for only certain software may be updated, may prevent the user from defining or redefining the software updates to be implemented, may prevent all software updates, or some combination thereof.

In stage 710, the infrastructure retrieves the software updates to be implemented. For example, the control unit may retrieve the software updates from the network via a networking unit (such as the networking unit 208 (FIG. 2)) of the infrastructure, may retrieve the software updates from the memory device, or some combination thereof.

In stage 712, the infrastructure updates the software of the vehicle. In particular, the control unit may cause the software operated by the in-vehicle electronics to be updated via the communication unit. The control unit may transmit data for the software updates to be implemented for the in-vehicle electronics to the in-vehicle electronics via the communication unit, where the data causes the software of the in-vehicle electronics to be updated.

In stage 714, the procedure 600 may implement a diagnostic operation. The diagnostic operation may initiate at stage 714. In stage 714, the infrastructure establishes a communication connection with the vehicle. In particular, the establishment of the communication connection in stage 714 includes the features of the establishment of the communication connection in stage 606.

In stage 716, the infrastructure authenticates a user. The authentication of the user in stage 716 includes the features of the authentication of the user in stage 608. In instances where the infrastructure determines that the user is not authorized, the diagnostic operation may be terminated, the diagnostic operation may proceed with reduced functionality, the corrective measures performed by the infrastructure may be limited, or some combination thereof. In some embodiments where the infrastructure determines that the user is not authorized, the infrastructure may implement corrective measures that shut down one or more of the vehicle systems (such as vehicle starter systems and/or vehicle drive train systems) in order to prevent further use of the vehicle by the user that is not authorized and facilitate recovery of stolen vehicles. In instances where the infrastructure determines that the user is authorized, the diagnostic operation proceeds with full functionality.

In stage 718, the infrastructure retrieves data from the vehicle. In particular, the control unit retrieves data from the in-vehicle electronics via the communication unit. The data includes data associated with operation of one or more of the vehicle systems of the vehicle.

In stage 720, the infrastructure identifies operation characteristics of the one or more of the vehicle systems. In particular, the control unit analyzes the data associated with the vehicle systems retrieved via the communication unit. The control unit identifies operation characteristics (such as battery health/depreciation of a battery of the vehicle, oil levels of the vehicle, measurements of engine operation, indications of vehicle issues identified by the in-vehicle electronics, measurements of drive train operation, and/or measurements of traction elements) of the vehicle systems from the data.

In stage 722, the infrastructure determines whether the vehicles systems are operating properly. In particular, the control unit compares one or more of the operation characteristics with values associated with proper operation of the vehicle systems to determine if the vehicle systems are operating properly. The values associated with proper operation can be retrieved from the memory device and/or from the network via the networking unit. The control unit determines that the vehicle systems are not operating properly based on the operation characteristics being different than, or outside of a range of, the values associated with proper operation of the vehicle systems. In some embodiments where the operation characteristics can include indications of vehicle issues identified by the in-vehicle electronics, the control unit 202 may determine whether the vehicle systems are operating properly by determining whether the operation characteristics include any indications of vehicle issues. If the control unit determines that the vehicle systems are operating properly, the diagnostic operation can be terminated. If the control unit determines that one or more of the vehicle systems are not operating properly, the diagnostic operation can proceed to stage 724.

In stage 724, the infrastructure performs corrective measures in response to determining that one or more of the vehicle systems are not operating properly. In particular, the control unit initiates one or more corrective measures in response to determining that one or more of the vehicle systems are not operating properly. The corrective measures include notifying the user of the vehicle of the vehicle systems that are not operating properly, reconfiguring the vehicle systems to correct operation of the vehicle systems, notifying a third party (such as a vehicle manufacturer, a maintenance provider, and/or an owner of the vehicle in instances where the owner is not the user). For example, the control unit can cause an indication of the vehicle systems that are not operating properly and/or the operation characteristics associated with the vehicle systems to be displayed to the user via the interface unit on a display of the infrastructure and/or a device of the user. The control unit can reconfigure the vehicle systems to operate properly via the communication unit. Further, the control unit can provide an indication of the vehicle systems that are not operating properly and/or the operation characteristics associated with the vehicle systems to be transmitted to the third party via the network and the networking unit.

FIG. 8 illustrates another operation of the example procedure 600 of FIG. 6 for an infrastructure, according to various embodiments. FIG. 8 illustrates one additional operation that can be performed by an infrastructure. The operation can be performed concurrently or separately from operations illustrated in FIG. 7 and FIG. 8.

The procedure 600 may initiate with stage 602, as described in relation to FIG. 6. The procedure 600 may implement one or more of the additional operations based on detecting the presence of the vehicle in stage 602. From stage 602, the procedure 600 may proceed to the user prompt operation in stage 603, as described in relation to FIG. 6.

From stage 602, the procedure may proceed to a tour guide provision operation. The tour guide provision operation initiates at stage 802. In stage 802, the infrastructure establishes a communication connection with the vehicle. Establishing the communication connection in stage 802 includes the features of establishing the communication connection in stage 606 (FIG. 6).

In stage 804, the infrastructure retrieves tour guide information. In particular, the control unit retrieves the tour guide information from the memory device, the network via the networking unit, or some combination thereof. The tour guide information can include an audio guide associated with a location of the infrastructure, operation calls that cause the in-vehicle electronics to initiate one or more operations of the vehicle (such as displaying objects/information on windows of the vehicles, highlighting, on the windows, objects viewable through the windows of the vehicle, magnifying, via the windows, objects viewable through the windows, zooming in, via the windows, on objects viewable through the windows, displaying objects/information on displays of the vehicles, and/or causing sensors/elements of the vehicle to capture certain information), or some combination thereof. Further, the tour guide information can include indications of times and/or locations when portions of the audio guide are to be rendered and/or the operations of the vehicles are to be performed. For example, the infrastructure can be located at a national park, a state park, a local park, a historical location/landmark, or a point of interest. The tour guide information includes an audio guide and/or operation calls that act as a tour guide for the location. In some embodiments, the operation calls can include an operation call or operation calls that cause one or more cameras of the vehicle to capture photos and/or videos of the inside of the vehicle and/or outside of the vehicle while the audio guide and/or the operation calls are being rendered by the vehicle and/or at certain times while the audio guide and/or the operation calls are being rendered. The captured photos and/or videos can be included in the data retrieved from the vehicle during the data download operation. All events performed or IVI can be recorded and/or used as a ledger anytime in the future, or uploaded to be shared

In stage 806, the infrastructure provides the tour guide information to the vehicle. In particular, the control unit causes the tour guide information to be provided to the vehicle via the communication unit. The vehicle can then utilize the tour guide information to operate as a tour guide for the national park, the state park, the local park, the historical location/landmark, or the point of interest.

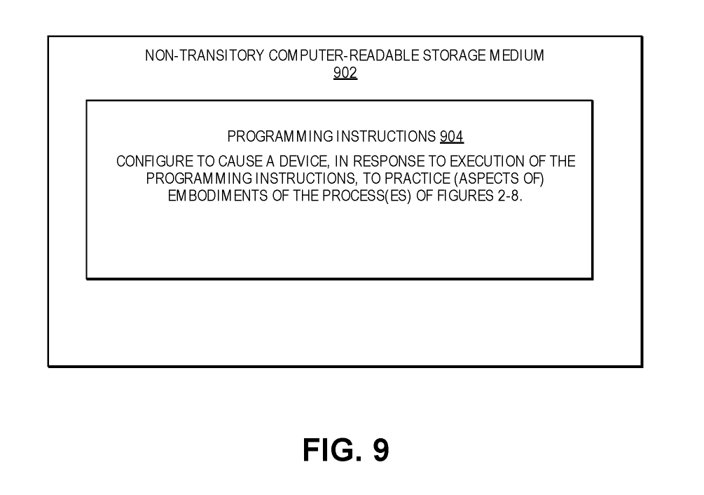

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 9 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 902 may include a number of programming instructions 904. Programming instructions 904 may be configured to enable a device, e.g., control unit 202 (FIG. 2), in response to execution of the programming instructions, to implement (aspects of) the procedures and/or processes described herein. In alternate embodiments, programming instructions 904 may be disposed on multiple computer-readable non-transitory storage media 902 instead. In still other embodiments, programming instructions 904 may be disposed on computer-readable transitory storage media 902, such as signals.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments may be implemented as a computer process, as a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Example 1 may include an apparatus for servicing a computer-assisted or autonomous driving (CA/AD) vehicle, comprising an energy re-supply unit to re-charge or re-fuel the CA/AD vehicle, a communication unit to exchange data with in-vehicle electronics of the CA/AD vehicle when the communication unit is communicatively coupled with the CA/AD vehicle while the CA/AD vehicle is proximally disposed near the apparatus enabling to apparatus to re-charge or re-fuel the CA/AD vehicle, a memory device coupled to the communication unit to store data received from the in-vehicle electronics by the communication unit, a networking unit to couple the memory device to a network external to the apparatus, the networking unit to provide for exchange of data between the memory device and another device coupled to the network, and a control unit coupled to the energy re-supply unit, the communication unit, the memory device and the networking unit to control operations of the energy re-supply unit, the communication unit, the memory device and the networking unit.

Example 2 may include the apparatus of example 1 or any other example herein, wherein the control unit is arranged to cause the communication unit to exchange data with the in-vehicle electronics of the CA/AD vehicle, with or without causing the energy re-supply unit to re-charge or re-fuel the CA/AD vehicle, or cause the energy re-supply unit to re-charge or re-fuel the CA/AD vehicle, with or without causing the communication unit to exchange data with the in-vehicle electronics of the CA/AD vehicle.

Example 3 may include the apparatus of example 1 or any other example herein, wherein the control unit is further arranged to cause the networking unit to provide data received into the memory device, from the in-vehicle electronics of the CA/AD vehicle, to the other device coupled to the network, in real time, while the communication unit is receiving data from the in-vehicle electronics of the CA/AD vehicle, or cause the networking unit to provide data received into the memory device, from the in-vehicle electronics of the CA/AD vehicle, to the other device coupled to the network, at a subsequent point in time, after the communication unit has received data from the in-vehicle electronics of the CA/AD vehicle.

Example 4 may include the apparatus of example 1 or any other example herein, wherein the control unit is further arranged to cause the communication unit to provide data received into the memory device, from the other device coupled to the network, to the in-vehicle electronics of the CA/AD vehicle, in real time, while the networking unit is receiving data from the other device coupled to the network, or cause the communication unit to provide data received into the memory device, from the other device coupled to the network, at an earlier point in time, to the in-vehicle electronics of the CA/AD vehicle.

Example 5 may include the apparatus of example 1 or any other example herein, further comprising a sensor unit coupled to the control unit, the sensor unit to detect a presence of the CA/AD vehicle while the CA/AD vehicle is proximally disposed near the apparatus, and an interface unit coupled to the control unit, the interface unit to cause a user prompt to be displayed to a user of the CA/AD vehicle, wherein the user prompt requests an indication of one or more operations to be implemented by the control unit, and detect the indication of the one or more operations indicated by the user, wherein the control unit is to implement the one or more operations in response to detection of the indication of the one or more operations by the interface unit.

Example 6 may include the apparatus of example 5 or any other example herein, wherein the interface unit includes wireless circuitry to establish a wireless connection with a device of the user, wherein the user prompt is displayed on the device of the user, and wherein to detect the indication of the one or more operations includes to identify a transmission of the device of the user that includes the indication of the one or more operations.

Example 7 may include the apparatus of example 5 or any other example herein, further comprising a body that houses the memory device, the networking unit, and the control unit, wherein a portion of the body is arch-shaped or upside-down U-shaped, wherein the portion of the body forms a recess to receive a portion of the CA/AD vehicle, and wherein to detect the presence of the CA/AD vehicle includes to determine that the portion of the CA/AD vehicle is located within the recess.

Example 8 may include the apparatus of example 1 or any other example herein, further comprising an interface unit coupled to the control unit, the interface unit to provide interaction with a user of the CA/AD vehicle, wherein the control unit is to cause the interface unit to retrieve information utilized for authentication of the user, determine that the user is not an authorized user based on the information, and prevent performance of one or more of operations available to be performed by the apparatus in response to the determination that the user is not the authorized user.

Example 9 may include the apparatus of example 1 or any other example herein, further comprising a sensor unit coupled to the control unit, the sensor unit to detect a presence of the CA/AD vehicle while the CA/AD vehicle is proximally disposed near the apparatus, wherein the control unit is to retrieve tour guide information from the memory device or the networking unit, and provide the tour guide information to the in-vehicle electronics via the communication unit, wherein the tour guide information includes an audio guide that is to rendered by the CA/AD vehicle or an operation call that is to cause the in-vehicle electronics to initiate an operation of the CA/AD vehicle.

Example 10 may include one or more computer-readable media having instructions stored thereon, the instructions, in response to execution by a processor of an apparatus for servicing a computer-assisted or autonomous driving (CA/AD) vehicle, cause the processor to detect, via a sensor unit of the apparatus, a presence of the CA/AD vehicle located within a proximity of the apparatus, identify an indication of one or more operations to be performed by the apparatus received, via an interface unit of the apparatus, from a user of the CA/AD vehicle, and implement the one or more operations, wherein the one or more operations include to exchange data with in-vehicle electronics of the CA/AD vehicle, or re-charge or re-fuel the CA/AD vehicle.

Example 11 may include the computer-readable media of example 10 or any other example herein, wherein the one or more operations include a data download operation, wherein the data download operation includes to establish, via a communication unit of the apparatus, a communication connection with the in-vehicle electronics, retrieve, via the communication unit, data from the in-vehicle electronics, wherein the data includes route information of the CA/AD vehicle, vehicle operation information of the CA/AD vehicle, vehicle system operation information of the CA/AD vehicle, or data captured by one or more sensors of the CA/AD vehicle, and store the data on a memory device of the apparatus.

Example 12 may include the computer-readable media of example 11 or any other example herein, wherein the data download operation further includes identify a portion of the data to be transmitted to a network external to the apparatus, and transmit, via a networking unit of the apparatus, the portion of the data to another device coupled to the network.

Example 13 may include the computer-readable media of example 10 or any other example herein, wherein the one or more operations include a software update operation, wherein the software update operation includes to establish, via a communication unit of the apparatus, a communication connection with the in-vehicle electronics, retrieve, via the communication unit, data from the in-vehicle electronics, wherein the data includes data associated with operation of a vehicle system of the CA/AD vehicle, and determine whether the vehicle system is operating properly based on the data.

Example 14 may include the computer-readable media of example 13 or any other example herein, wherein the processor determines that the vehicle system is not operating properly based on the data, wherein the software update operation further includes to perform one or more corrective measures in response to the determination that the vehicle system is not operating properly, and wherein the one or more corrective measures includes notifying the user that the vehicle system is not operating properly, reconfiguring the vehicle system to correct operation of the vehicle system, or notifying a third party that the vehicle system is not operating properly.

Example 15 may include the computer-readable media of example 10 or any other example herein, wherein the instructions, in response to execution by the processor, cause the processor to perform authentication of the user to determine whether the user is an authorized user of the CA/AD vehicle, and prevent implementation of one or more other operations available to be performed by the apparatus in response to a determination that the user is not the authorized user of the CA/AD vehicle.

Example 16 may include the computer-readable media of example 10 or any other example herein, wherein to implement the one or more operations includes to concurrently exchange data with the in-vehicle electronics and re-charge or re-fuel the CA/AD vehicle.

Example 17 may include a method to be performed by an apparatus for servicing a computer-assisted or autonomous driving (CA/AD) vehicle, comprising establishing, via a communication unit of the apparatus, a communication connection with in-vehicle electronics of the CA/AD vehicle, retrieving authentication information for a user of the CA/AD vehicle, determining, based on the authentication information, whether the user is an authorized user of the CA/AD vehicle, and determining, based on the determination of whether the user is the authorized user, which operations for servicing the CA/AD vehicle are available to the user, wherein the operations include a re-charge/re-fuel operation and one or more exchange of data operations.

Example 18 may include the method of example 17 or any other example herein, further comprising preventing performance of one or more of the operations for servicing the CA/AD vehicle in response to determining that the user is not the authorized user.

Example 19 may include the method of example 17 or any other example herein, further comprising prompting, via an interface unit of the apparatus, the user for an indication of one or more operations to be performed by the apparatus, identifying the indication of the one or more operations to be performed by the apparatus received via the interface unit, and implementing the one or more operations to be performed by the apparatus based on a determination that the user is the authorized user.

Example 20 may include the method of example 19 or any other example herein, wherein implementing the one or more operations includes re-charging or re-fueling the CA/AD vehicle while performing a data download operation, performing a software update operation, performing a diagnostic operation, or performing a tour guide provision operation.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus for servicing a computer-assisted or autonomous driving (CA/AD) vehicle, comprising:
an energy re-supply unit to re-charge or re-fuel the CA/AD vehicle;
a communication unit to exchange data with in-vehicle electronics of the CA/AD vehicle when the communication unit is communicatively coupled with the CA/AD vehicle while the CA/AD vehicle is proximally disposed near the apparatus enabling to apparatus to re-charge or re-fuel the CA/AD vehicle;
a memory device coupled to the communication unit to store data received from the in-vehicle electronics by the communication unit;
a networking unit to couple the memory device to a network external to the apparatus, the networking unit to provide for exchange of data between the memory device and another device coupled to the network; and
a control unit coupled to the energy re-supply unit, the communication unit, the memory device and the networking unit to control operations of the energy re-supply unit, the communication unit, the memory device and the networking unit.

2. The apparatus of claim 1, wherein the control unit is arranged to cause the communication unit to exchange data with the in-vehicle electronics of the CA/AD vehicle, with or without causing the energy re-supply unit to re-charge or re-fuel the CA/AD vehicle, or cause the energy re-supply unit to re-charge or re-fuel the CA/AD vehicle, with or without causing the communication unit to exchange data with the in-vehicle electronics of the CA/AD vehicle.

3. The apparatus of claim 1, wherein the control unit is further arranged to cause the networking unit to provide data received into the memory device, from the in-vehicle electronics of the CA/AD vehicle, to the other device coupled to the network, in real time, while the communication unit is receiving data from the in-vehicle electronics of the CA/AD vehicle, or cause the networking unit to provide data received into the memory device, from the in-vehicle electronics of the CA/AD vehicle, to the other device coupled to the network, at a subsequent point in time, after the communication unit has received data from the in-vehicle electronics of the CA/AD vehicle.

4. The apparatus of claim 1, wherein the control unit is further arranged to cause the communication unit to provide data received into the memory device, from the other device coupled to the network, to the in-vehicle electronics of the CA/AD vehicle, in real time, while the networking unit is receiving data from the other device coupled to the network, or cause the communication unit to provide data received into the memory device, from the other device coupled to the network, at an earlier point in time, to the in-vehicle electronics of the CA/AD vehicle.

5. The apparatus of claim 1, further comprising:
a sensor unit coupled to the control unit, the sensor unit to detect a presence of the CA/AD vehicle while the CA/AD vehicle is proximally disposed near the apparatus; and
an interface unit coupled to the control unit, the interface unit to:
cause a user prompt to be displayed to a user of the CA/AD vehicle, wherein the user prompt requests an indication of one or more operations to be implemented by the control unit; and
detect the indication of the one or more operations indicated by the user, wherein the control unit is to implement the one or more operations in response to detection of the indication of the one or more operations by the interface unit.

6. The apparatus of claim 5, wherein the interface unit includes wireless circuitry to establish a wireless connection with a device of the user, wherein the user prompt is displayed on the device of the user, and wherein to detect the indication of the one or more operations includes to identify a transmission of the device of the user that includes the indication of the one or more operations.

7. The apparatus of claim 5, further comprising a body that houses the memory device, the networking unit, and the control unit, wherein a portion of the body is arch-shaped or upside-down U-shaped, wherein the portion of the body forms a recess to receive a portion of the CA/AD vehicle, and wherein to detect the presence of the CA/AD vehicle includes to determine that the portion of the CA/AD vehicle is located within the recess.

8. The apparatus of claim 1, further comprising an interface unit coupled to the control unit, the interface unit to provide interaction with a user of the CA/AD vehicle, wherein the control unit is to:
cause the interface unit to retrieve information utilized for authentication of the user;
determine that the user is not an authorized user based on the information; and
prevent performance of one or more of operations available to be performed by the apparatus in response to the determination that the user is not the authorized user.

9. The apparatus of claim 1, further comprising a sensor unit coupled to the control unit, the sensor unit to detect a presence of the CA/AD vehicle while the CA/AD vehicle is proximally disposed near the apparatus, wherein the control unit is to:
retrieve tour guide information from the memory device or the networking unit; and
provide the tour guide information to the in-vehicle electronics via the communication unit, wherein the tour guide information includes an audio guide that is to rendered by the CA/AD vehicle or an operation call that is to cause the in-vehicle electronics to initiate an operation of the CA/AD vehicle.

10. One or more computer-readable media having instructions stored thereon, the instructions, in response to execution by a processor of an apparatus for servicing a computer-assisted or autonomous driving (CA/AD) vehicle, cause the processor to:
detect, via a sensor unit of the apparatus, a presence of the CA/AD vehicle located within a proximity of the apparatus;
identify an indication of one or more operations to be performed by the apparatus received, via an interface unit of the apparatus, from a user of the CA/AD vehicle; and
implement the one or more operations, wherein the one or more operations include to exchange data with in-vehicle electronics of the CA/AD vehicle, or re-charge or re-fuel the CA/AD vehicle.

11. The computer-readable media of claim 10, wherein the one or more operations include a data download operation, wherein the data download operation includes to:
establish, via a communication unit of the apparatus, a communication connection with the in-vehicle electronics;
retrieve, via the communication unit, data from the in-vehicle electronics, wherein the data includes route information of the CA/AD vehicle, vehicle operation information of the CA/AD vehicle, vehicle system operation information of the CA/AD vehicle, or data captured by one or more sensors of the CA/AD vehicle; and
store the data on a memory device of the apparatus.

12. The computer-readable media of claim 11, wherein the data download operation further includes:
identify a portion of the data to be transmitted to a network external to the apparatus; and
transmit, via a networking unit of the apparatus, the portion of the data to another device coupled to the network.

13. The computer-readable media of claim 10, wherein the one or more operations include a software update operation, wherein the software update operation includes to:
establish, via a communication unit of the apparatus, a communication connection with the in-vehicle electronics;
retrieve, via the communication unit, data from the in-vehicle electronics, wherein the data includes data associated with operation of a vehicle system of the CA/AD vehicle; and
determine whether the vehicle system is operating properly based on the data.

14. The computer-readable media of claim 13, wherein the processor determines that the vehicle system is not operating properly based on the data, wherein the software update operation further includes to perform one or more corrective measures in response to the determination that the vehicle system is not operating properly, and wherein the one or more corrective measures includes notifying the user that the vehicle system is not operating properly, reconfiguring the vehicle system to correct operation of the vehicle system, or notifying a third party that the vehicle system is not operating properly.

15. The computer-readable media of claim 10, wherein the instructions, in response to execution by the processor, cause the processor to:
perform authentication of the user to determine whether the user is an authorized user of the CA/AD vehicle; and
prevent implementation of one or more other operations available to be performed by the apparatus in response to a determination that the user is not the authorized user of the CA/AD vehicle.

16. The computer-readable media of claim 10, wherein to implement the one or more operations includes to concurrently exchange data with the in-vehicle electronics and re-charge or re-fuel the CA/AD vehicle.

17. A method to be performed by an apparatus for servicing a computer-assisted or autonomous driving (CA/AD) vehicle, comprising:
establishing, via a communication unit of the apparatus, a communication connection with in-vehicle electronics of the CA/AD vehicle;
retrieving authentication information for a user of the CA/AD vehicle;
determining, based on the authentication information, whether the user is an authorized user of the CA/AD vehicle; and
determining, based on the determination of whether the user is the authorized user, which operations for servicing the CA/AD vehicle are available to the user, wherein the operations include a re-charge/re-fuel operation and one or more exchange of data operations.

18. The method of claim 17, further comprising preventing performance of one or more of the operations for servicing the CA/AD vehicle in response to determining that the user is not the authorized user.

19. The method of claim 17, further comprising:
prompting, via an interface unit of the apparatus, the user for an indication of one or more operations to be performed by the apparatus;
identifying the indication of the one or more operations to be performed by the apparatus received via the interface unit; and
implementing the one or more operations to be performed by the apparatus based on a determination that the user is the authorized user.

20. The method of claim 19, wherein implementing the one or more operations includes re-charging or re-fueling the CA/AD vehicle while performing a data download operation, performing a software update operation, performing a diagnostic operation, or performing a tour guide provision operation.
